(19) United States
(12) Patent Application Publication
(10) Pub. No.: US 2017/0059152 A1
(43) Pub. Date: Mar. 2, 2017

(54) System and Method for Prevention of LED Light Spillage

(71) Applicant: BRAGI GmbH, Munchen (DE)

(72) Inventors: Eric Christian Hirsch, Munchen (DE); Karin Schlierenkaemper, Munchen (DE)

(21) Appl. No.: 15/244,937

(22) Filed: Aug. 23, 2016

Related U.S. Application Data
(60) Provisional application No. 62/211,729, filed on Aug. 29, 2015.

(51) Int. Cl. F21V 33/00; H04R 1/10; H05B 37/02; F21V 15/01; F21V 19/00; F21V 31/00

(52) U.S. Cl. CPC F21V 33/0056; F21V 19/003; F21V 31/00; H05B 37/0227; F21V 15/01; H04R 1/1041; F21Y 2115/10

(57) ABSTRACT

A method for designing an electronic device including. at least one LED light source to reduce spillage of light from the at least one LED light source includes designing a housing, designing a printed circuit board for placement within the housing, positioning the at least one LED light source on the printed circuit board, and positioning a plurality of electronic components around the at least one LED light source on the printed circuit board to reduce spillage of the light from the at least one LED light source. The electronic device may be an in ear device and the housing may be an ear piece housing.

### PRIORITY STATEMENT

This application claims priority to U.S. Provisional Patent Application No. 62/211,729 hereby incorporated by reference in its entirety.

### FIELD OF THE INVENTION

The present invention relates to wearable devices which include light emitting diodes (LEDs). More particularly, but not exclusively, the present mention relates to in ear headphones.

### BACKGROUND OF THE ART

In ear headphones are spatially limited by the size of the user's external auditory canal and pima, Given such limitations, monitoring sensors are necessarily space limited as well. At the same time, however, such systems are required for proper device function. One such example is a device requiring at least one LED light source. Emissions of the LED introduce varying levels of light spillage. Such levels of light spillage in significantly confined structures are problematic by introducing unacceptably high levels of artifact. These artifacts may produce false negative or false positive results. Various methods have been suggested to limit this side spillage of the generated light. These include the use of expensive LEDs with coned apertures. Such apertures limit the effective amount of side spillage. These have the disadvantage of much greater size and cost. Another method of controlling side spillage is through the use of baffles or shields. These systems have the disadvantage of increasing both the size and the bulk of the device. What is needed is a new way to prevent light spillage from LED light sources.

### SUMMARY

Therefore, it is to primary object, feature, or advantage to improve over the state of the art.

It is a further object, feature, or advantage to prevent light spillage from LED light sources.

A still further object, feature, or advantage of the present invention is to provide for preventing light spillage in a manner that is not cost prohibitive and is commercially viable.

Another object, feature, or advantage of the present invention is to provide for a reduction of weight of a device.

Yet another object, feature, or advantage of the present invention provides for the prevention of the necessity of utilization of expensive LED light sources.

A further object, feature, or advantage of the present invention is to minimize the required footprint of available LED light sources,

A still further object, feature, or advantage of the present invention is to allow for maximal use of all required electronic componentry.

Another object, feature, or advantage is to minimize the weight of the device required for device construction.

Yet another object, feature, or advantage is to minimize the number of components required for device construction.

A further object, feature, or advantage of the present invention is to simplify the device construction through minimizing the number of required components.

One or more of these and/or other objects, features, or advantages of the present invention will become apparent from the specification and claims that follow. No single embodiment need exhibit each and every object, feature, or advantage. It is contemplated that different embodiments may have different objects, features, or advantages.

According to one aspect, a method for designing an electronic device including at least one LED light source to reduce spillage of light from the at least one LED light source is provided. The method includes designing a housing, designing a printed circuit board for placement within the housing, positioning the at least one LED light source on the printed circuit board, and positioning a plurality of electronic components around the at least one LED light source on the printed circuit board to reduce spillage of the light from the at least one LED light source. The electronic device may be an in-ear device and the housing may be an ear piece housing. The electronic components may be of various types.

According, to another aspect, an electronic device is provided. The electronic device includes a housing, a printed circuit board disposed within the housing, at least one LED light source mounted to the printed circuit board, and a plurality of electronic components positioned around the at least one LED light source to block light from the at least one LED light source and reduce spillage. The electronic device may be an in-ear device and the housing may be an ear piece housing. The device may further include a light guide in operative communication with the at least one LED light source. The electronic components may be of various types.

### BRIEF DESCRIPTION OF THE DRAWINGS

FIG. 1 is a perspective view of one embodiment of a wearable device.

FIG. 2 is another view of a wearable device.

FIG. 3 is a block diagram of a device.

FIG. 4 illustrates a method.

### DETAILED DESCRIPTION

A novel approach to the prevention of side spillage from the LED light source is accomplished through the buildup of the electronic components of the device to effectively block such side spillage. This novel technique allows the minimum necessary components of the structure to be used. At the same time, the invention allows for blockage of the scattered segments emitted from the LED source not useful for device control functions in an economical fashion. Further, it allows for the electronics package to take maximal use of the limited available space. It has a further advantage of maintaining the lightest weight possible through the use of already required component sets.

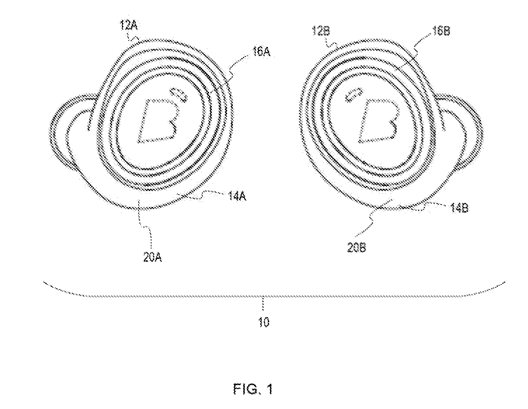

FIG. 1 illustrates one example of an electronic device in the form of a wearable or personal area device in the form of a set of in-ear ear pieces 10 including a first earpiece 10A and a second ear piece 108. The earpiece may be used in multiple modalities. The device may provide multiple functions including functions of interest to a user performing sports activities, the transmission of audio information for two way conversations, and the measurement of numerous biometric data sets. Of course, the earpiece may also perform additional functions.

Although such a device preferably performs a number of different functions, it is preferred that the wearable or personal area device be relatively simple and/or intuitive in operation. In addition, because the device may be used during sports activities it is preferred that the device be water resistant or otherwise adapted for harsh environments. Where the device is water resistant, it is preferred that the device allows the user to interact with it when in the water such as a swimming pool, lake, or ocean.

It should thus be appreciated that where the device is an ear piece, the single small device preferably performs numerous functions. One way in which the device may communicate with users is through the use of colorimetric light is used to give visual data and/or feedback to the user. The device may provide the user feedback over operational controls of the device, activate optional features, confirm gestural movements, allow for assessment of embedded device data such as device build, serial number, build date, etc. as well as to provide for an alternative method for software upload, download and analysis of data, and diagnostic purposes. It is the use of these LEDs used to produce the colorimetric light which may be create LED spillage.

FIG. 1 illustrates one example of a wearable device in the form of a set of earpieces 10 including a left ear piece 12A and a right earpiece 12B. Each of the ear pieces 12A, 12B has as housing 14A, 14B which may be in the form of a protective shell or casing and may be an in-the-ear earpiece housing. A light display area 16A, 16B is present on each of the ear pieces 12A, 12B. The light display areas 16A, 16B each provide for producing light of one or more colors. Ore or more LED(s) 20A, 20B may be positioned within the ear pieces 12A, 12B in order to generate light which is piped or otherwise communicated to the light display areas 16A, 16B.

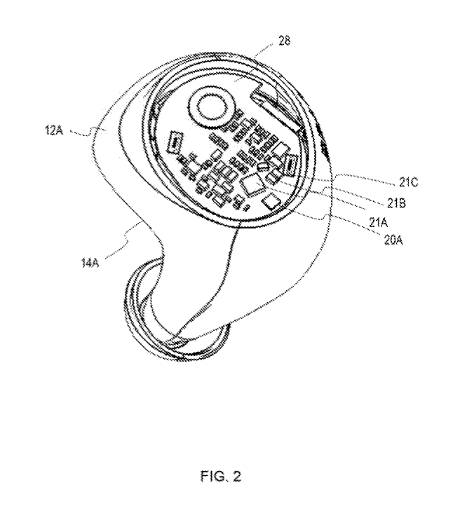

FIG. 2 illustrates an ear piece 12A with a housing 14A with a portion of the housing 14A removed to show a printed circuit board 30. One or more LED(s) 20A may be mounted to the printed circuit board 28. In use, light emitted from the one or more LED(s) 20A may spill into the device. However, placement of a plurality of electronic components 21A, 21B, 21C around the one or more LED(s) 20A results in reducing the light spillage. The electronic components may include various types of electronic components of various package sizes.

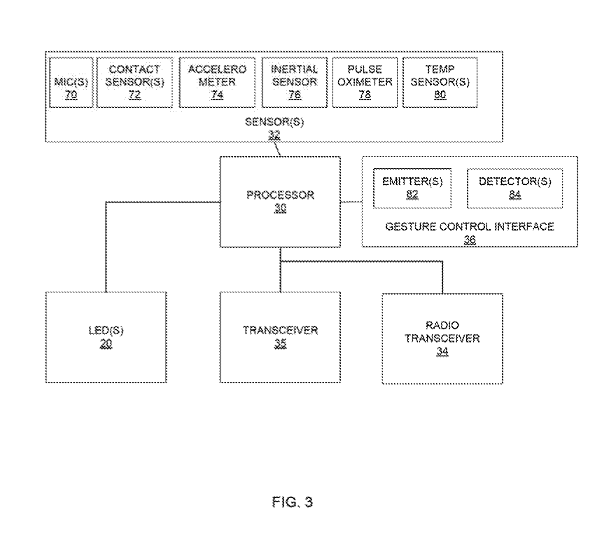

FIG. 3 is a block diagram illustrating a device. The device may include one or more LEDs 20 electrically connected to a processor 30. The processor 30 may also be electrically connected to one or more sensors 32. Where the device is an earpiece, the sensor(s) may include an inertial sensor 76, an accelerometer 74, one or more contact sensors 72, a bone conduction microphone or air conduction microphone 70, a pulse oximeter 76, a temperature sensor 80, or other biological sensors. A gesture control interface 36 is also operatively connected to the process 30. The gesture control interface 36 may include one or more emitters 82 and one or more detectors 84 for sensing user gestures. The emitters may he of any number of types including infrared LEDs. The device may include a transceiver 35 which may allow for induction transmissions such as through near field magnetic induction. A short range transceiver 34 using Bluetooth, UWB, or other means of radio communication may also be present. in operation, the processor 30 may be programmed to convey different information using one or more of the LED(s) 20 based on context or mode of operation of the device. The various sensors 32, the processor 30, and other electronic components may be located on the printed circuit board of the device.

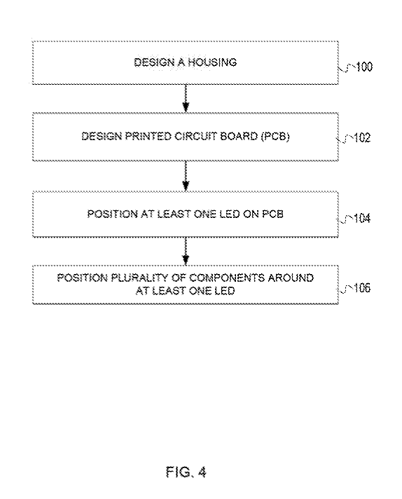

FIG. 4 illustrates one example of a method. Although various steps are shown and described with respect to the design process, it is to be understood that the steps may occur in different orders and that the design process is iterative in nature. As shown in FIG. 4, in step 400 a housing is designed. In one example, the housing is designed to be an ear piece housing for an in-ear device. In step 402, a printed circuit board is designed for placement within the housing. In step 404, at least one LED light source is positioned on the printed circuit board. In step 406, a plurality of electronic components are positioned around the at least one LED light source on the printed circuit board to reduce spillage of the light from the at least one LED light source.

Therefore, various examples of systems, devices, apparatus, and methods for preventing LED light spillage. Although various embodiments and examples have been set forth, the present invention contemplates numerous variations, options, and alternatives.

What is claimed is:

1. A method for designing an electronic device including at least one LED light source to
reduce spillage of light from the at least one LED light source, the method comprising:
designing a housing;
designing a primed circuit board for placement within the housing;
positioning the at least one LED light source on the printed circuit board;
positioning a plurality of electronic components around the at least one LED light source on the primed circuit board to reduce spillage of the light from the at least one LED light source.

2. The method of claim 1 wherein the electronic device is an in-ear device and wherein the housing is an ear piece housing.

3. The method of claim 1 wherein the plurality of the electronic components around the at least one LED light source on the printed circuit board include at least one sensor.

4. The method of claim 1 further comprising positioning a light guide in operative communication with the at least one LED source.

5. An electronic device, comprising:
a housing;
a printed circuit board disposed within the housing;
at least one LED light source mounted to the printed circuit board;
a plurality of electronic components positioned around the at least one LED light source to block light from the at least one LED light source and reduce spillage.

6. The electronic device of claim 5 wherein the electronic device is an in-ear device and wherein the housing is an ear piece housing.

7. The electronic device of claim 6 wherein the plurality of electronic components include at least one sensor.

8. The electronic device of claim 7 wherein the electronic, device, further comprises a light guide in operative communication with the at least one LED source.
